(19) United States
(12) Patent Application Publication
(10) Pub. No.: US 2010/0202911 A1
(43) Pub. Date: Aug. 12, 2010

(54) SCROLL-TYPE POSITIVE DISPLACEMENT APPARATUS WITH PLASTIC SCROLLS

(75) Inventors: Shimao NI, Bolingbrook, IL (US); Zhen REN, Shanghai (CN)

Correspondence Address: HAMRE, SCHUMANN, MUELLER & LARSON, P.C., P.O. BOX 2902, MINNEAPOLIS, MN, 55402-0902, US

(73) Assignee: SCROLL LABORATORIES, INC., Bolingbrook, IL (US)

(21) Appl. No.: 12/701,856

(22) Filed: Feb. 8, 2010

Related U.S. Application Data
(60) Provisional application No. 61/151,914, filed on Feb. 12, 2009.

(51) Int. Cl. F01C 1/063; B29C 45/14

(52) U.S. Cl. 418/55.2; 425/120

(57) ABSTRACT

At least one of the scroll members is composed of a metallic insert having substantial the same configuration of the scroll member, i.e. an end plate and spiral wraps fixed to and extended from the end plate. The metallic insert has anchor holes and connecting holes for bonding the plastic coating layer on to the metallic insert. The anchor holes also serve as gas escaping passages during injection molding process. The mold has multiple poring gates to minimize the pressure gradients across the spiral wraps during the injection molding process. The metallic insert has also tubers sticking out from the tip of its spiral wraps. The tubers are firmly held by the mold in the injection molding process to prevent movement of the spiral wraps under the pressure from the injected plastic flow. The metallic inserts can be fully or partially coated by the plastic compound such that there is no metallic to metallic contact between the scroll members during operations.

### RELATED APPLICATION

This application claims the benefit of U.S. Provisional Application No. 61/151,914, filed Feb. 12, 2009.

### FIELD

This disclosure relates to a scroll-type positive fluid displacement apparatus and more particularly to a scroll-type apparatus having an improved axially and radially compliant floating scroll mechanism.

### BACKGROUND

There is known in the art a class of devices generally referred to as “scroll” pumps, compressors and expanders, wherein two interfitting spiroidal or involute spiral elements are conjugate to each other and are mounted on separate end plates forming what may be termed as fixed and orbiting scrolls. These elements are interfitted to form line contacts between spiral elements.

A pair of adjacent line contacts and the surfaces of end plates form at least one sealed off pocket. When one scroll, i.e. the orbiting scroll, makes relative orbiting motion, i.e. circular translation, with respect to the other, the line contacts on the spiral walls move along the walls and thus changes the volume of the sealed off pocket. The volume change of the pocket will expand or compress the fluid in the pocket, depending on the direction of the orbiting motion.

U.S. Pat. No. 4,802,831 to Suefuji et al. discloses a method to form scroll members. Each scroll member is composed of a metallic base scroll member having a spiral wrap formed on one side and a coating layer of a resin compound formed on the said side of the scroll member, including the surfaces of the wrap. However, the bonding strength of the resin compounds with the metallic insert completely depend on the adhesive strength which is not enough in the most case and lead to premature separation of the coating layer with the metallic insert during operation. Furthermore, modern advanced thermal plastic material needs to be injected under high pressure at high temperature. The traditional insert injection molding methods revealed in the prior invention unavoidably lead to the consequence that the injected resin under high pressure flowing around the metallic insert will distort the metallic insert due to tremendous pressure gradient in the resin flow. In addition the modern engineering thermal composite materials, such as Victrex PEEK and so on, are good heat insulator. It is desirable to maximize metallic surface of the scroll members to conduct heat from the compression chambers to enhance heat dissipation.

### SUMMARY

An improved scroll-type fluid displacement apparatus, where the metallic inserts of the insert injection molded scroll members are formed with structure to greatly reduce the pressure gradient of the plastic flow across the spiral wall of the metallic insert to keep the metallic insert in its designated position, is provided.

One advantage of the described scroll-type fluid displacement apparatus is to provide structures of the metallic inserts and the corresponding mold of the injection molding to reinforce the metallic insert during the molding process to avoid the distortion caused by the plastic flow pressure gradient.

Another advantage of the described scroll-type fluid displacement apparatus is to provide structures on the metallic insert to fix the plastic layer on to the metallic insert by not only the plastic layer adhesive strength, but also by mechanical anchoring force.

Still another advantage of the described scroll-type fluid displacement apparatus is to provide a structure of scroll members with metallic inserts which are partially molded on by plastic layer such that plastic-metallic contact between the mating scroll members are maintained during operation.

Another advantage of the described scroll-type fluid displacement apparatus is to provide a structure of metallic insert injection mold parts that can conduct heat out from the compression chambers.

### DRAWINGS

For a fuller understanding of the invention, reference should be made to the following detailed description taken in connection with the accompanying drawings in which:

FIG. 1 is a cross-sectional view of a prior art showing an insert injection molded orbiting scroll;

FIG. 2 is a sectional view of a mold of the prior art used for molding a resin compound on the orbiting scroll metallic insert to mold the orbiting scroll member shown in FIG. 1,

FIG. 3 is a cross-sectional view of an orbiting scroll metallic insert injection molded scroll member in accordance to the present invention;

FIG. 4 is a cross-sectional view of the orbiting scroll metallic insert of the present invention;

FIG. 5 is a directional view taken in FIG. 4 in the direction of arrow A;

FIG. 6 is a perspective view of the orbiting scroll metallic insert as shown in FIG. 4;

FIG. 7 is a cross-sectional view of a mold used for molding a thermal plastic compound on the orbiting scroll metallic insert to mold the orbiting scroll member in accordance to the present invention;

FIG. 8 is a cross-sectional view of an orbiting scroll member with partial plastic coating layer on the tip and upper part of the spiral wrap and peripheral base surface of the end plate in accordance to the present invention;

FIG. 9 is a cross-sectional vies of a fixed scroll member with partial plastic coating layer on the tip and upper part of the spiral wrap in accordance to the present invention;

FIG. 10 illustrates engaged orbiting and fixed scroll members with partial plastic coating layer the tip and upper part of the spiral wrap.

FIG. 11 is a cross-sectional view of an orbiting scroll member with partial plastic coating layer on the lower part of the spiral wrap and base surface of the end plate in accordance to the present invention;

FIG. 12 is a cross-sectional vies of a fixed scroll member with partial plastic coating layer on the lower part of the spiral wrap and base surface of the end plate in accordance to the present invention;

FIG. 13 illustrates engaged orbiting and fixed scroll members with partial plastic coating layers on the lower part of the spiral wraps and base surfaces of the end plates.

FIG. 14 is a cross-sectional view of an orbiting scroll member with partial plastic coating layer on the convex surface and the tip of the spiral wrap and base surface of the end plate in accordance to the present invention;

FIG. 15 is a cross-sectional vies of a fixed scroll member with partial plastic coating layer on the convex surface and the tip of the spiral wrap and base surface of the end plate in accordance to the present invention;

FIG. 16 illustrates engaged orbiting and fixed scroll members with partial plastic coating layer on their convex surfaces and the tips of the spiral wraps and base surfaces of the end plates. There contacts of plastic coating layer vs. metallic surfaces are maintained.

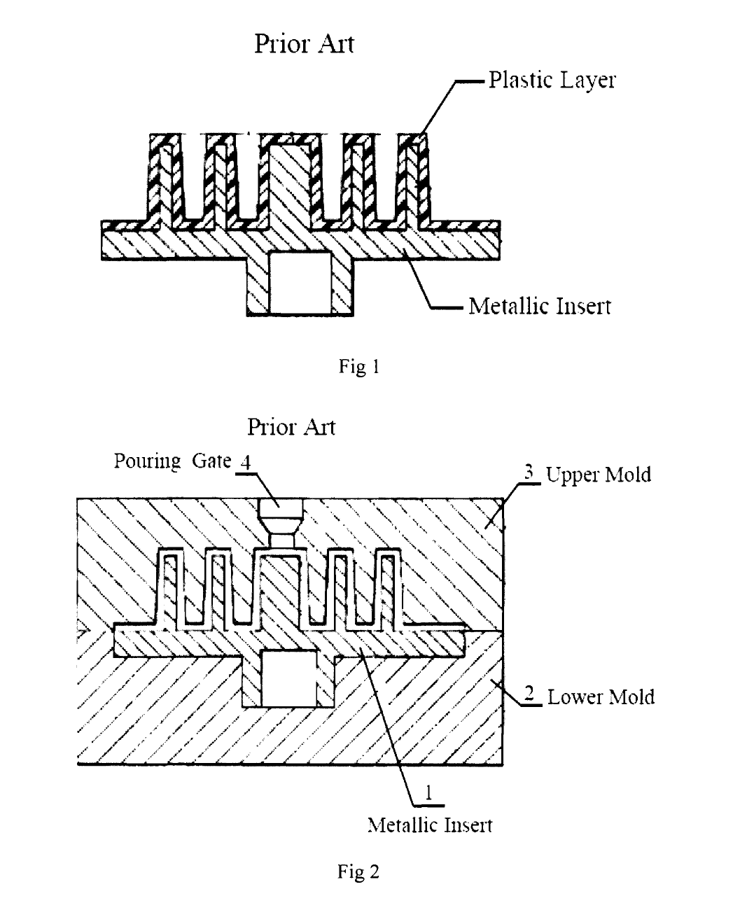

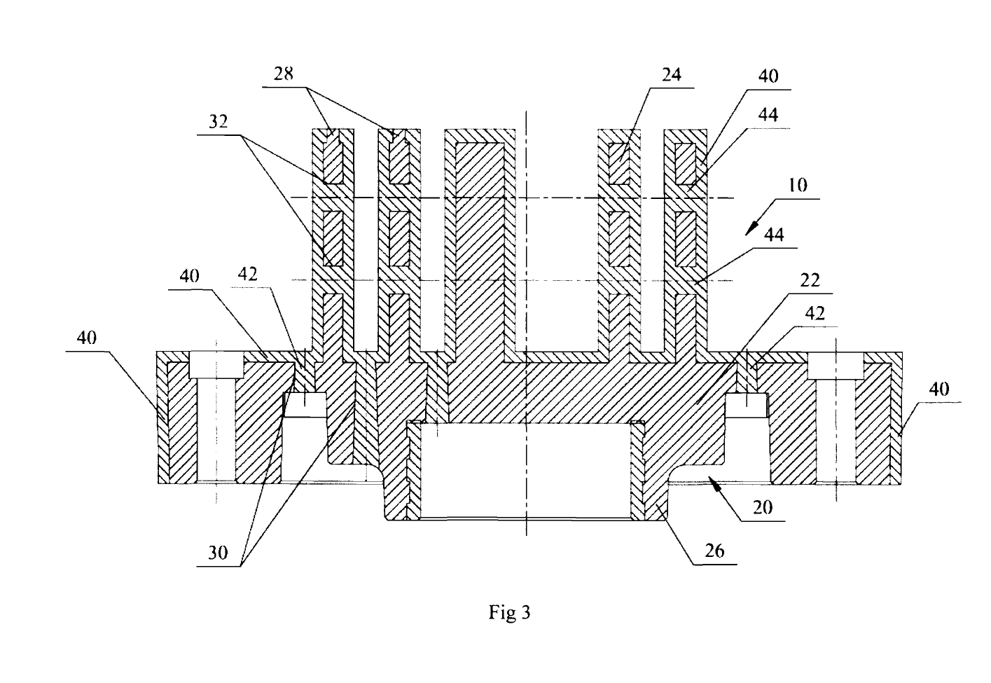

### DETAILED DESCRIPTION

For simplicity only insert injection molded orbiting scroll member is described in the context, the fixed scroll member can be insert injection molded in the same way.

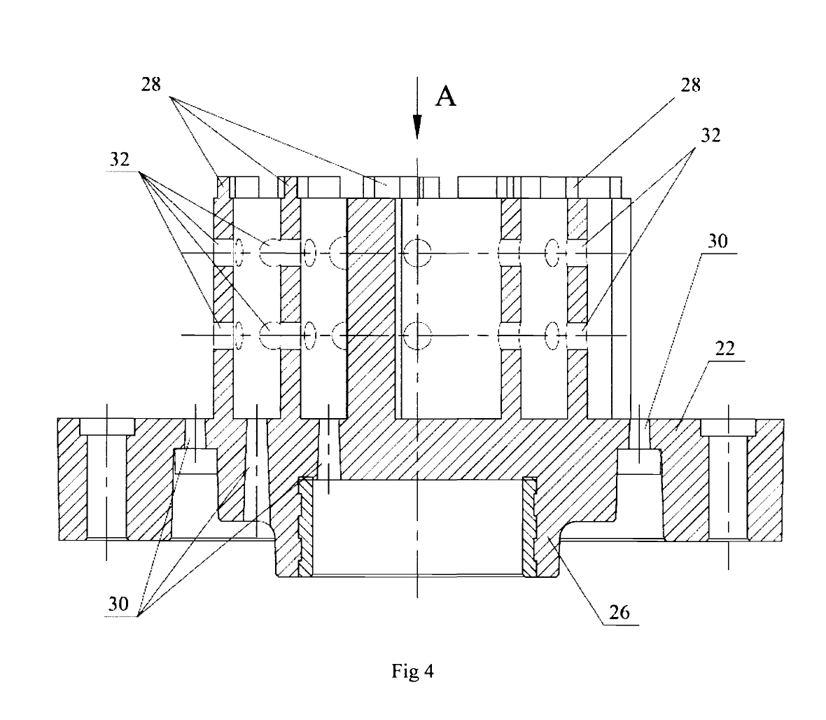

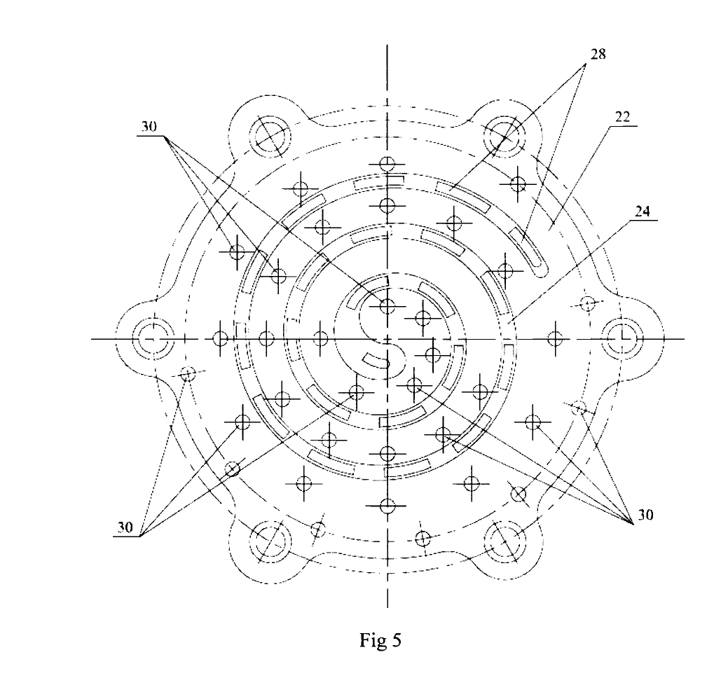

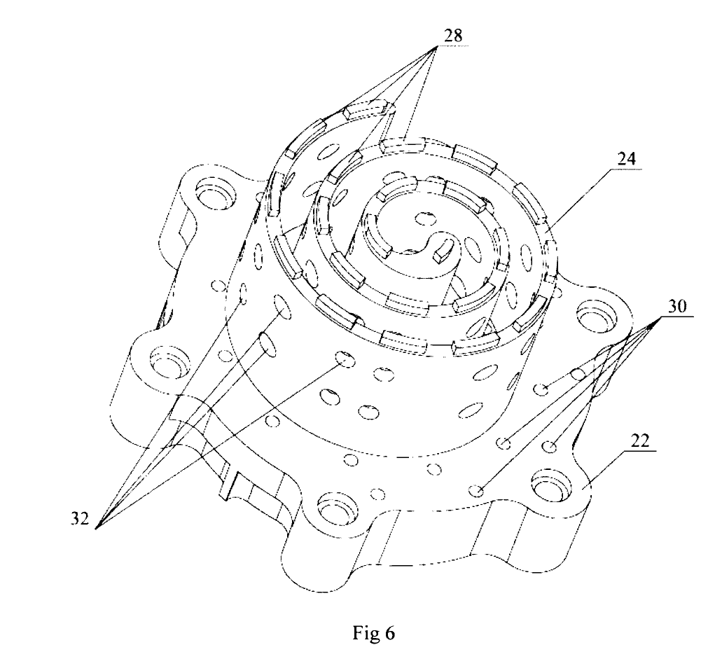

Referring to FIG. 3, an insert injection molded orbiting scroll member in accordance to the present invention is shown. An insert injection molded orbiting scroll member 10 consists of an orbiting scroll metallic insert 20, which usually is made of aluminum alloy, stainless steel or other suitable materials depending on different applications. The orbiting scroll metallic insert has general features of an orbiting scroll member. Referring to FIGS. 3, 4 and 5, the orbiting scroll metallic insert consists of a circular end plate 22, scroll element 24 affixed to and extending from the front surface of the end plate 22, and orbiting bearing hub 26 affixed to and extending from the rear surface of the central portion of end plate 22. For simplicity, not all anchor holes 30 are indicated by lead line and number 30. Similar are true for fix tubers 28 and connecting holes 32. Anchor holes 30 are through holes on the end plate 22 and are distributed over the end plate 22 serves two purposes. First, anchor holes 30 provide gas escape passages as plastic compound flows into the mold to form a plastic layer 40, coated onto the metallic insert 20 during injection molding. Second, anchor holes 30 will be filled with plastics as anchors 42, to anchor the plastic layer 40 onto the base surface of the end plate 22 of metallic insert 20. We will revisit the function of anchor holes 30 when the injection molding process is explained below. Connecting holes 32 are through holes on the scroll element 24 of the metallic insert 20 and filled with plastic by injection molding to form connecting rods 44 connecting the plastic layers 40 on the opposite sides of the scroll element 24 of metallic insert 20 together to greatly enhance the binding and adhesive forces of the plastic layer 40 to the orbiting scroll metallic insert 20. At the tip of the scroll element 24 of orbiting scroll metallic insert 20 there are fix tubers 28 projected. The fix tubers 28 protruded into the corresponding recesses of the mold to hold the spiral scroll element 24 unmovable when it is under the pressure gradient of the injected plastic flow during the molding process. A perspective view of orbiting scroll metallic insert 20 is shown in FIG. 6 for better understanding of its configuration.

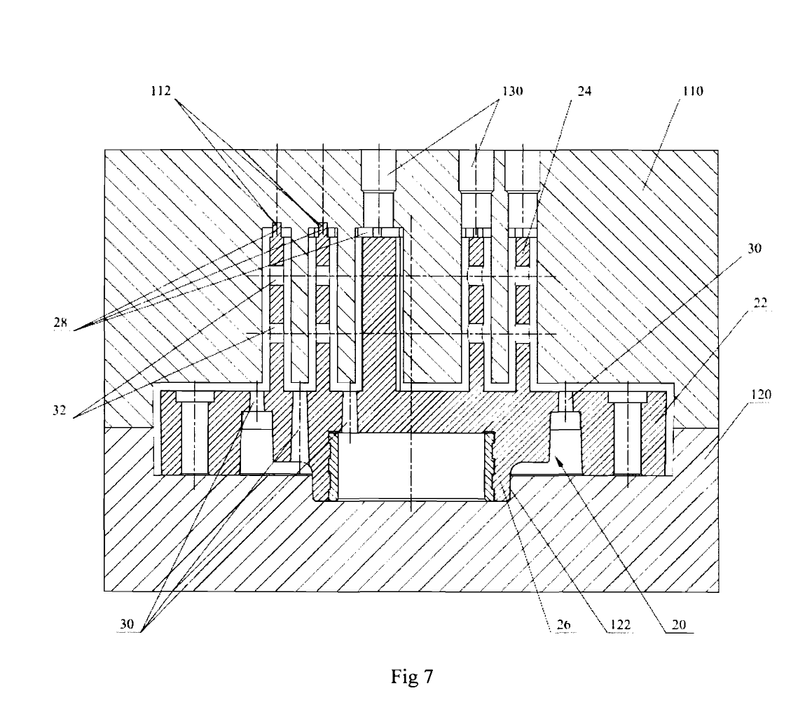

Referring to FIG. 7, upper mold 110 and lower mold 120 are shown. Orbiting scroll metallic insert 20 is located in the space between upper and lower molds 110 and 120. The orbiting scroll hub 26 is fit into the recess 122 of lower mold 120. Fix tubers 28 are fitted into recesses 112 of upper mold 110 to reinforce the orbiting scroll element 24 of the metallic insert 20 from deforming under the plastic flow as it is injected into the mold. During the orbiting scroll metallic insert plastic injection molding process, the heated thermal plastic, for example the Victrex Polyetheretherketone PEEK 450FC30, flows under a few thousands psig pressure into the mold through multiple poring gates 130. The poring ports 130 and the anchor holes 30 are distributed such that the air trapped in the mold can escape through anchor holes 30 to eliminate the voids formed by trapped gas inside the plastic layer. The plastic flows through poring gates 130 into the mold along the both sides of the scroll element 24 of the metallic insert 20. Although the plastic flows are under high pressure, the pressure gradient across the scroll element 24 of the metallic insert 20 is not large due to the fact that plastic flows exert forces on the both sides of the spiral wall of the scroll element 24 of the metallic insert 20 simultaneously. The forces balance each other to assure the geometric integrity of the spiral wall of scroll element 24 of the metallic insert 20. In addition, the fix tubers 28 protrude and fit into their corresponding upper mold recesses 112 to hold the upper part of the scroll element 24 from move under the injected plastic flows. The fixed tubers 28 are auxiliary structure to reinforce the scroll wraps during injection molding process and will be machined off during the scroll member finish machining. The injected plastic flows into the mold and forms layer 40 bonded over the metallic insert 20 as shown in FIG. 3. The injected plastic further fills connecting holes 32 to form connecting rods 44 to link the plastic layer 40 on the both sides of scroll element 24 together. The injected plastic also fills anchor holes 30 to form anchors 42 anchoring the plastic coating layer 40 onto the base surface of the end plate 22 of the orbiting scroll member 10.

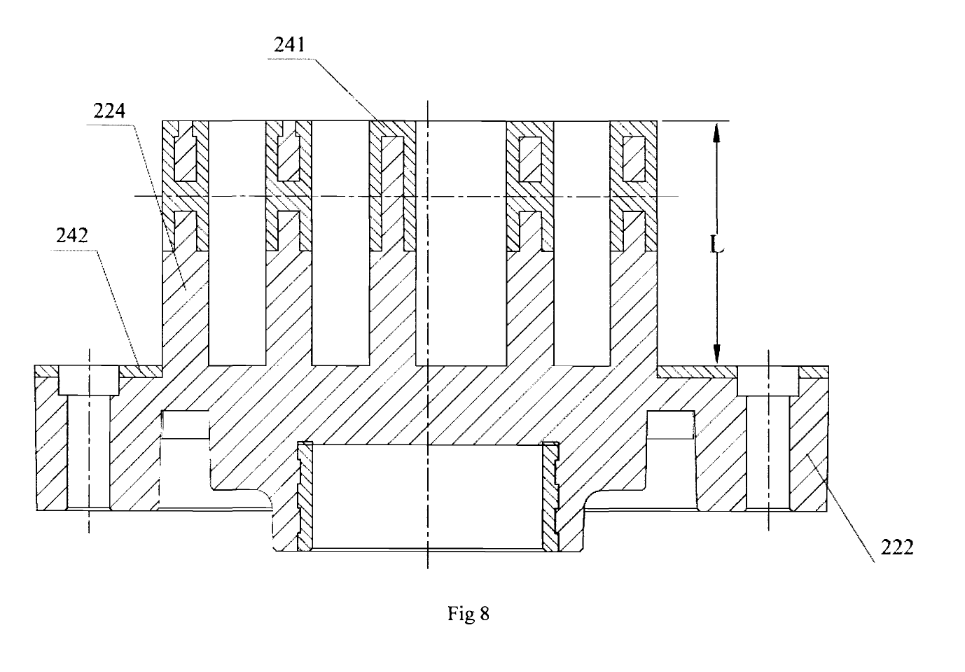

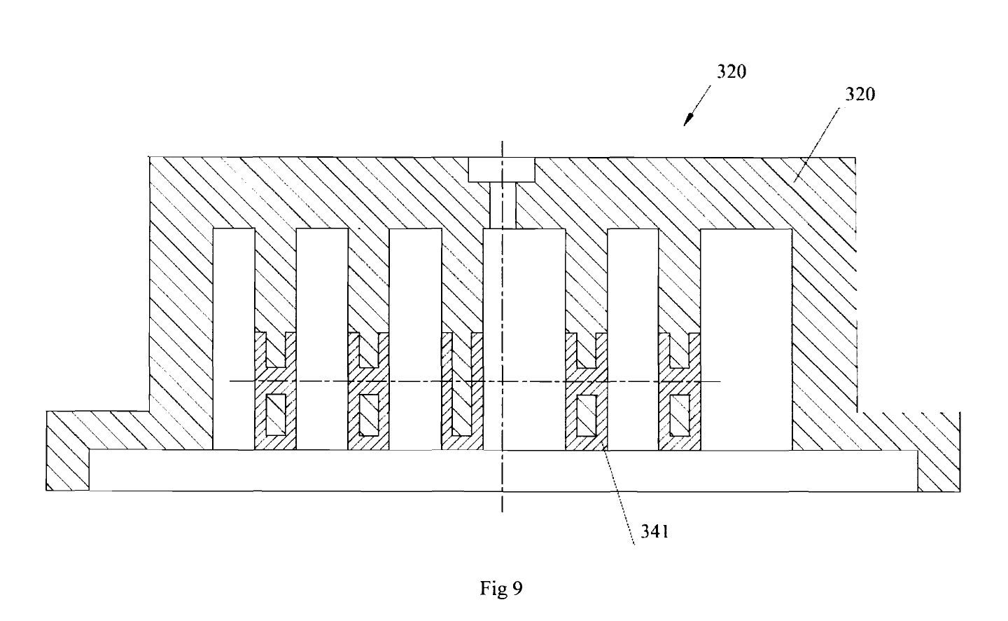

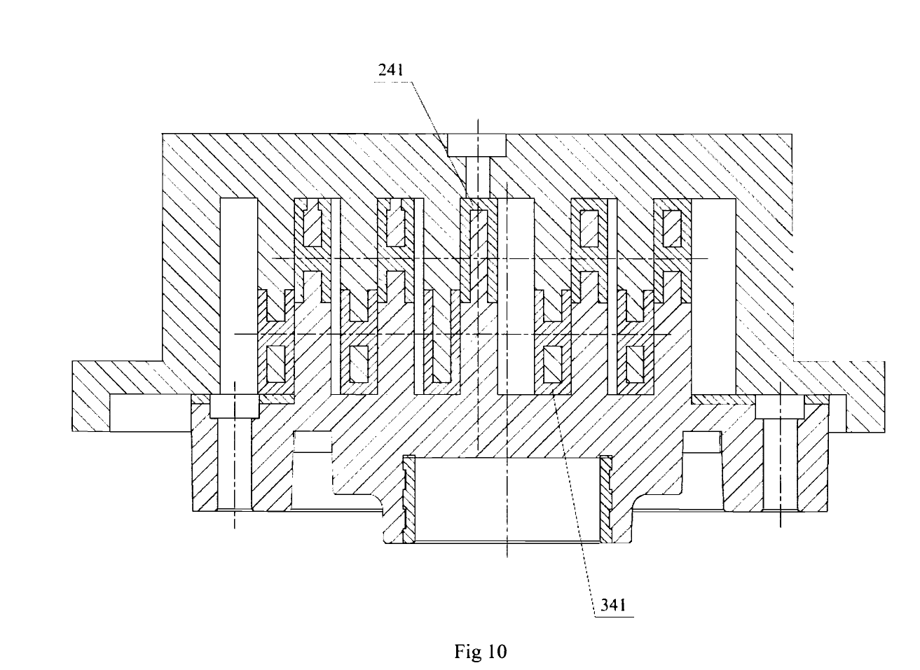

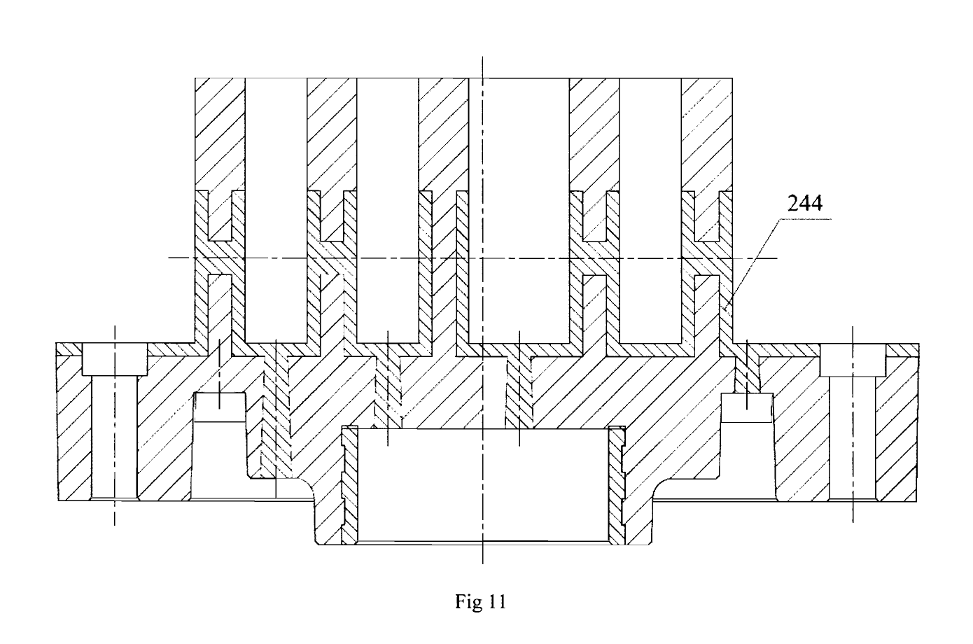

The second embodiment is shown in FIGS. 8, 9 and 10. The composite material coating layer 241, 341 and 242 cover the tips and upper part of the spiral wraps of the orbiting and fixed scroll members and the base surface of the orbiting scroll member, respectively. As shown in FIG. 10 there are two types of contact surfaces between the orbiting and fixed scroll members: plastic to metallic contact and plastic to plastic. The principle is to let the coated composite layers contact either the composite coated layer or metallic surface of its mating counterpart scroll member. But not metallic surface directly contacts metallic. This structure minimizes the coating layer surface and maximizes the metallic insert surface for both scroll members thus allows the metallic insert to conduct heat from the compression chambers out to be dissipated.

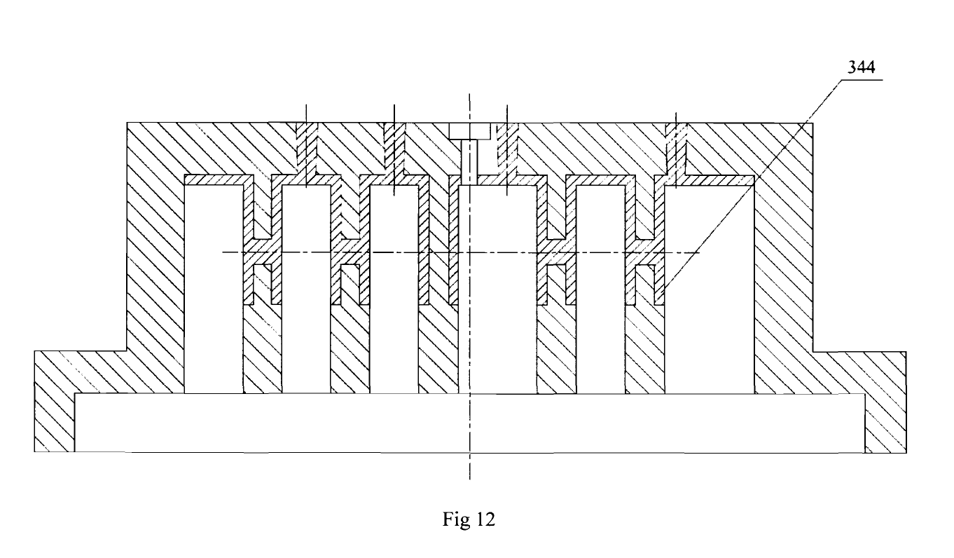

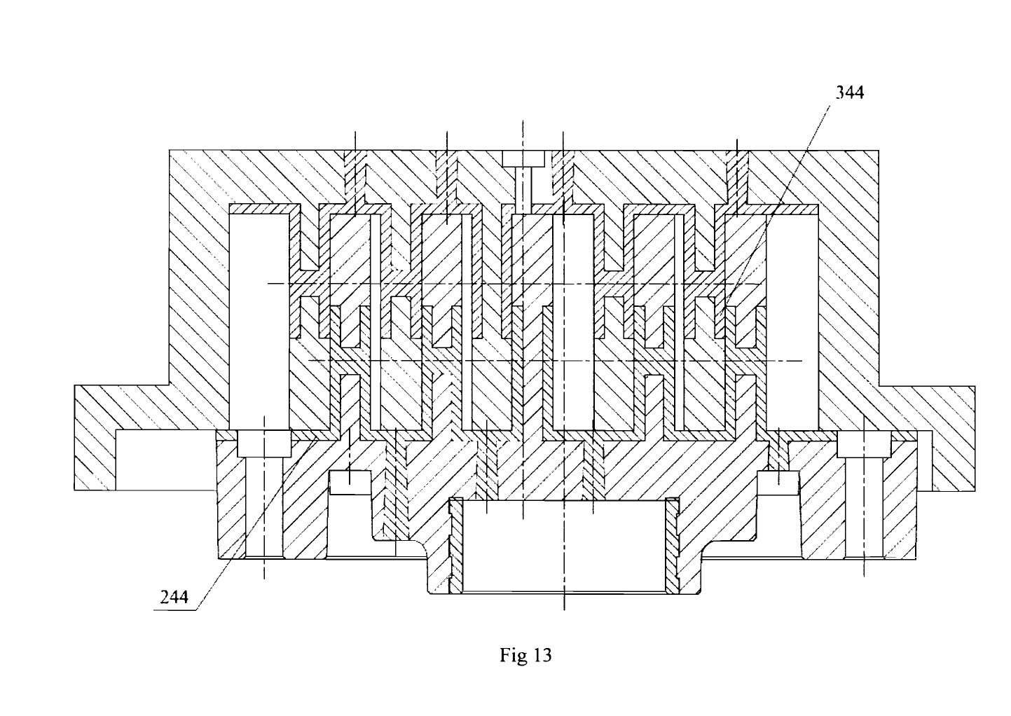

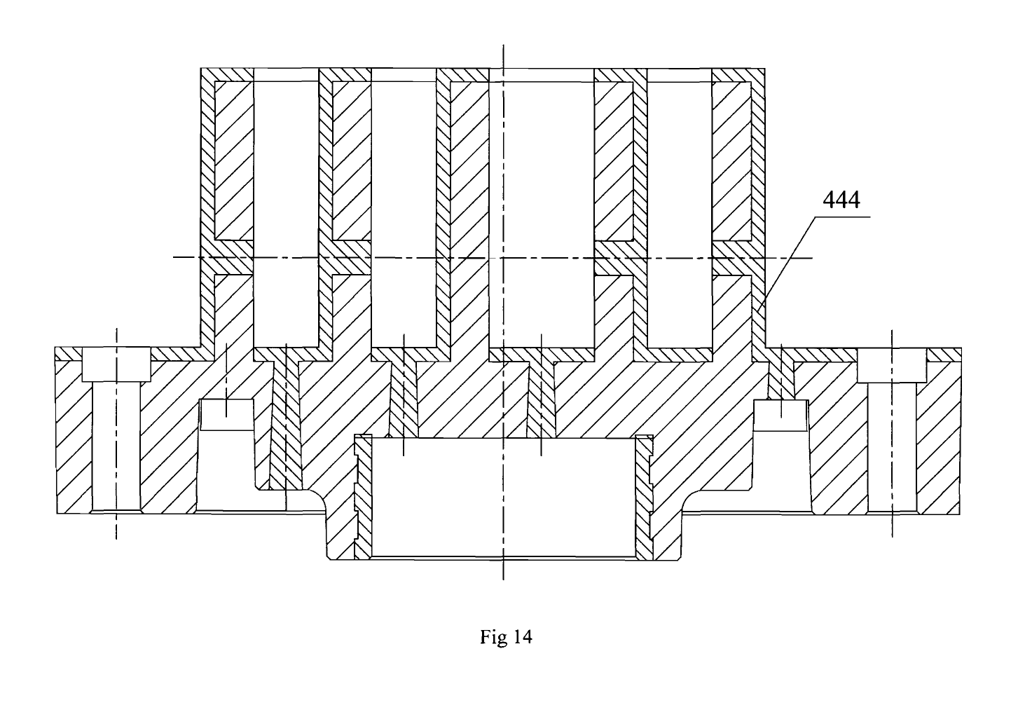

The third embodiment is shown in FIGS. 11, 12 and 13. The composite material coating layer 244 and 344 cover the base surfaces and lower part of the spiral wraps of the orbiting and fixed scroll members, respectively. As shown in FIG. 13 the contact surfaces of the orbiting and fixed scroll members include both coated composite layers and the metallic surfaces of metallic inserts of the orbiting and fixed scroll members. This structure also minimizes the coating layer surface and maximizes the metallic insert surface and thus allows the metallic insert to conduct heat in the compression chambers out to be dissipated to the surrounding.

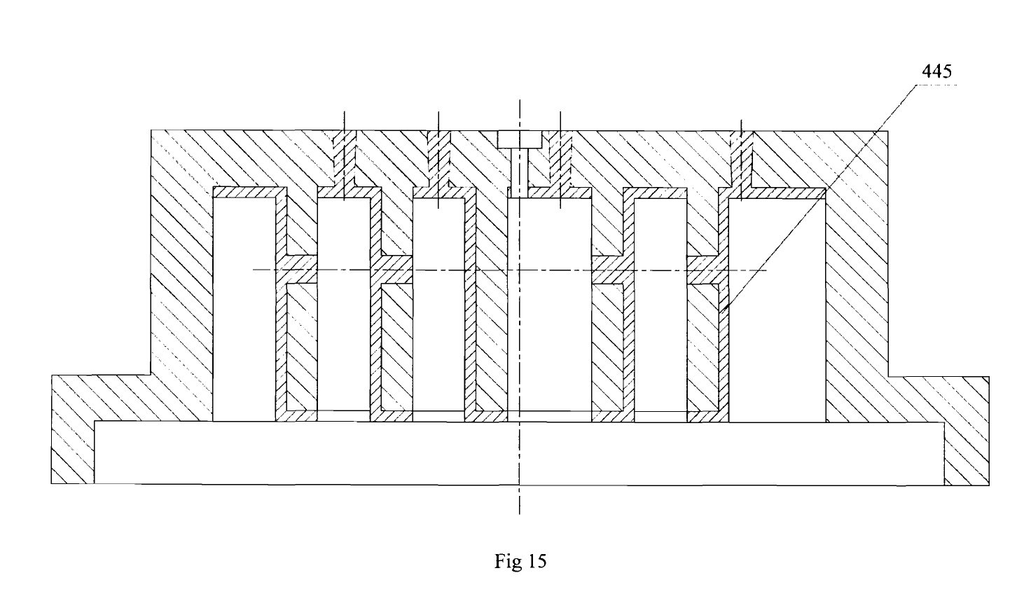

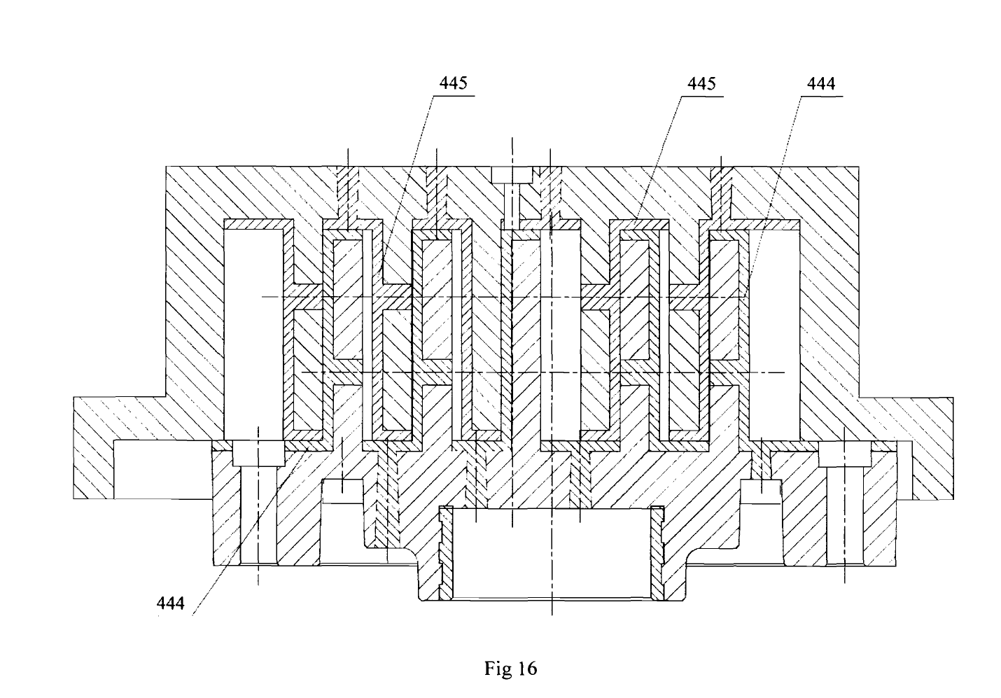

The fourth embodiment is shown in FIGS. 14, 15 and 16. The composite material coating layer 444 and 445 cover the base surfaces, and tip and convex surface of the spiral wraps of the orbiting and fixed scroll members, respectively. As shown in FIG. 16 the surface contacts between the orbiting and fixed scroll members take place between coated composite layers and the metallic surfaces. Theoretically, the coating layer on the spiral surfaces can be either on concave or convex sides. As far as the plastic coating is used due to the shrinkage of the plastic coating layer after injection molding the layer is bond better on the convex side of the spiral surface. This structure also minimizes the coating layer surface and maximizes the metallic insert surface and thus allows the metallic insert to conduct heat in the compression chambers out to be dissipated to the surrounding.

The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A positive fluid displacement apparatus, comprising:
a) at least one orbiting scroll member with a first end plate having a first spiral wrap affixed to and extended from a base surface of said first end plate;
b) at least one stationary scroll member with a second end plate having a second spiral wrap affixed to and extended from a base surface of said second end plate of said stationary scroll member, said second spiral wrap engaged with said first spiral wrap of said orbiting scroll member, wherein when said orbiting scroll member orbits with respect to said stationary scroll member the flanks of said engaging wraps along with said base surface of said first end plate of said orbiting scroll member and said base surface of said second end plate of said stationary scroll member define moving pockets of variable volume and zones of high and low fluid pressures;
c) a rotatable shaft arranged to drive said orbiting scroll member to experience orbiting motion with respect to said stationary scroll member;
d) at least one of said scroll members consisting of a metallic insert and a coating layer of composite material;
e) said metallic insert having substantial the same configuration of said scroll member, including an end plate and a spiral wrap affixed to a base surface of said first end plate;
f) said metallic insert having anchor holes distributed on said end plate such that the injected composite material during an injection molding process can flow in along the both sides of said spiral wall and the gas inside the mold can escape through said anchor holes, said anchor holes will be filled by said composite material acting as anchors for said coating layer fixed to said end plate of said metallic insert.

2. A positive fluid displacement apparatus in accordance with claim 1, wherein said metallic insert has connecting holes on said spiral wraps; said connecting holes are through holes on said spiral wraps and generally perpendicular to the direction in which said spiral wraps extended from said base surface of said end plate of said metallic insert; said connecting holes are filled with composite material connecting the coating layer on the both sides of said spiral wraps together.

3. A positive fluid displacement apparatus in accordance with claim 1, wherein said spiral wraps of said metallic insert has multiple tubers extended from the tip surface of said spiral wrap of said metallic insert; said tubers are held firmly by mold during injection molding process to avoid movements of said spiral wraps of said metallic insert under the influence of the injected flows of the composite material.

4. An injection mold for composite material injection molding on said metallic insert in accordance with claim 3, wherein said mold has multiple poring gates allowing injected composite material flowing along both sides of said spiral wraps of said metallic insert; said mold allows gases to flow out through said anchor holes.

5. An injection mold in accordance with claim 4, wherein said mold holds said tubers firmly to avoid movements of said spiral wraps of said metallic insert during injection molding process.

6. A positive fluid displacement apparatus in accordance with claim 1, wherein at least a half of the height of said scroll wraps and tips and/or bases of said orbiting and/or stationary scroll members are coated with plastic compound such that during engagement between said scroll members there is no metal to metal contact between said orbiting and stationary scroll members.

7. A positive fluid displacement apparatus in accordance with claim 1, wherein at least the concave or the convex surfaces of said scroll wraps and tips and/or bases of said orbiting and/or stationary scroll members are coated with plastic compound such that during engagement between said scroll members there is no metal to metal contact between said orbiting and stationary scroll members.
